(19) United States
(12) Patent Application Publication
(10) Pub. No.: US 2026/0231881 A1
(43) Pub. Date: Aug. 13, 2026

(54) A DEVICE FOR THE DELIVERY OF A LIQUID PREPARATION TO A PLANT SUBSTRATE

(71) Applicant: Marko KOSTIC, Belgrade (RS)

(72) Inventor: Marko KOSTIC, Belgrade (RS)

(21) Appl. No.: 19/152,796

(22) PCT Filed: Jan. 31, 2024
(86) PCT No.: PCT/EP2024/052358

§ 371 Date: Jul. 31, 2025

(30) Foreign Application Priority Data
Feb. 1, 2023 (LU) LU503426

(51) Int. Cl. A01G 29/00

(52) U.S. Cl. CPC A01G 29/00

(57) ABSTRACT

A device and a method of operating the device, the device being in the form of a tube having a lumen and a first and second end for the delivery of a liquid preparation to a plant substrate, wherein the tube comprises: a flow control element in the lumen which, when contacted with a liquid preparation, absorbs liquid and swells to reduce the flow rate of the liquid preparation from a part of the lumen to the first end; and a closure at the first end; and which, once activated by mechanically deforming the flow control element and inserting the first end of the tube into a plant substrate, permits the liquid preparation to flow from the part of the lumen to the plant substrate.

### FIELD OF THE INVENTION

The present invention relates to a device in the form of a tube for the delivery of a liquid preparation to a plant substrate, wherein the flow rate of the liquid preparation is regulated. More specifically, the present invention may be used to deliver fertilizer or pesticides to potted plants.

### BACKGROUND OF THE INVENTION

Many owners of potted plants struggle to provide the necessary care and attention to their potted plants. This may result in poor plant health, such as wilting, browning, or even death.

It has been known to provide a plant feeder in the form of a tube shaped device filled with liquid means for the plants nutrition/protection, the composition of tube on both sides closed by the membranes and by the reservoir formed by the tube and the membranes, filled with liquid means for the plants nutrition/protection (see e.g., WO 2012/091595 A2).

There remains strong consumer demand for plant feeding devices which supply the correct amount of water, nutrients and plant protection products to potted plants.

### SUMMARY OF THE INVENTION

The present invention provides device in the form of a tube having a lumen and a first and second end for the delivery of a liquid preparation to a plant substrate, wherein the tube comprises: a flow control element in the lumen which, when contacted with a liquid preparation, absorbs liquid and swells to reduce the flow rate of the liquid preparation from a part of the lumen to the first end; and a closure at the first end; and which, once activated by mechanically deforming the flow control element and inserting the first end of the tube into a plant substrate, permits the liquid preparation to flow from the part of the lumen to the plant substrate.

In an embodiment, the tube comprises a mixing element to mix the liquid preparation in the tube if settling occurs due to standing.

In an embodiment, the tube comprises an obstacle on the inner surface of the tube which protrudes into the lumen to reduce the flow rate of the liquid preparation.

In an embodiment, the tube comprises an extendable part with accordion ribs, and wherein the flow control element is positioned in the extendable part.

In an embodiment, the tube comprises a score line between the first end and/or the second end and the flow control element which structurally weakens the tube and permits the tube to be broken.

In an embodiment, the device comprises a drilling element to activate the device.

In an embodiment, the drilling element further conducts the liquid preparation into the plant substrate.

In an embodiment, the device comprises a modifying element on the outer surface of the tube.

In an embodiment, wherein the closure and/or the flow control element are in the form of a cartridge which is inserted into the lumen of the tube at the first or second end.

In an embodiment, the flow control element is a hydrogel and/or an organic absorber.

Preferably, the hydrogel is sodium polyacrylate and/or potassium polyacrylate.

In an embodiment, the liquid preparation, the flow control element and/or the modifying element is impregnated or coated with a fragrant substance or combination of fragrant substances.

In an embodiment, the tube, the flow control element and/or the drilling element is a prebiotic, and/or the tube is impregnated or coated with a prebiotic.

The present invention also provides a method of activating a device according to the invention, wherein the method comprises mechanically deforming a part of the closure and a part of the flow control element to permit the liquid preparation to flow from the part of the lumen to the plant substrate.

The present invention also provides a computer program comprising computer executable instructions that, when executed by a processor, cause the processor to control an additive manufacturing apparatus to manufacture the device according to the invention.

### BRIEF SUMMARY OF THE FIGURES

FIG. 1 shows the tube of the device.

FIG. 2 shows the flow control element of the device which swells to partially or completely fill the cross-section of the lumen of the tube.

FIG. 3 shows the flow control element of the device or the mixing element of the device which can move in the lumen of the tube.

FIG. 4 shows the flow control element of the device in different forms.

FIG. 5. shows the tube of the device being single-layered, double-layered or multi-layered.

FIG. 6 shows the closure of the device being a foil in different forms and the closure of the device being a membrane.

FIG. 7 shows the closure of the device being a plug in different forms which is inserted into the lumen of the tube.

FIG. 8 shows the closure of the device being a plug in different forms which is pulled around the tube at the ends.

FIG. 9 shows the tube of the device wherein the walls of the tube are bonded or welded to form the closure and the tube further comprises a score line.

FIG. 10 shows the method of activating the device using the drilling element.

FIG. 11 shows the method of activating the device by piercing the closure and the flow control element using the drilling element.

FIG. 12 shows the method of activating the device by applying pressure to the outer surface of the tube.

FIG. 13 shows the method of activating the device by breaking the tube at the score line.

FIG. 14 shows one end of the tube of the device comprising a score line.

FIG. 15 shows the drilling element having the ability to conduct the liquid preparation into the plant substrate.

FIG. 16 shows a modular assembly of the device using a connector.

FIG. 17 shows a device comprising a modifying element in different forms and functions.

FIG. 18 shows the tube of the device comprising distortions or obstacles on the inner surface of the tube.

FIG. 19 shows a device made of a combination of opaque and transparent materials.

FIG. 20 shows the tube of the device in different shapes.

FIG. 21 shows parts of tube of the device being extendable or twisted or comprising a decoration.

FIG. 22 shows the method of activating the device comprising a part of the tube being extendable by stretching the extendable part.

FIG. 23 shows the cartridge of the device.

### DETAILED DESCRIPTION

The device in the form of a tube 1 according to the invention has a lumen 2 and a first and second end for the delivery of a liquid preparation 5 to a plant substrate, wherein the tube 1 comprises: a flow control element 6 in the lumen 2 which, when contacted with a liquid preparation 5, absorbs liquid and swells to reduce the flow rate of the liquid preparation 5 from a part of the lumen 2 to the first end; and a closure 3 at the first end; and which, once activated by mechanically deforming the flow control element 6 and inserting the first end of the tube 1 into a plant substrate, permits the liquid preparation 5 to flow from the part of the lumen 2 to the plant substrate.

If it is necessary to deliver the liquid preparation 5 to more than one plant in the plant substrate at the same time, it is necessary to place the device so that the liquid preparation 5 comes into contact with the roots of each of the more than one plants in the plant substrate. Preferably, the plant is a potted plant.

### The Tube

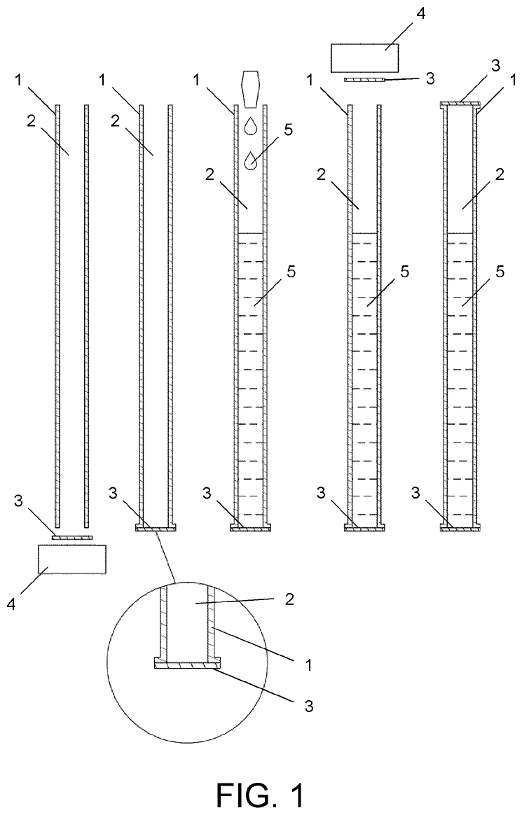

With reference to FIGS. 1 to 3, the tube 1 according to the invention has a lumen 2 and a first and second end, and comprises a flow control element 6 and a closure 3 at the first end. The closure 3 is attached to the first end of the tube 1 by pressure using a device 4, where the material is inextricably joined. The flow control element 6 is then inserted into the tube 1 before tube 1 is filled with the liquid preparation 5. Subsequently, the lumen 2 of the tube 1 is filled with the liquid preparation 5, after which a closure 3 is attached to the second end of the tube 1 with the same procedure to form the device. Alternatively, the flow control element 6 is inserted into the tube 1 at the same time as the lumen 2 of the tube 1 is filled with the liquid preparation 5, after which a closure 3 is attached to the second end of the tube 1 with the same procedure to form the device.

The tube 1 of the invention may be any size or shape. The size or shape of the tube 1 ensure the strength of the tube 1 sufficient to handle the device safely, eliminate the possibility of clogging the opening when placing it in the substrate, and provide the necessary amounts of liquid preparation 5 for one, two, or several plants in the plant substrate.

Preferably, the tube 1 has a diameter of less than 4 mm, less than 5 mm, less than 6 mm, less than 7 mm, less than 8 mm, less than 9 mm, less than 10 mm, less than 11 mm, less than 12 mm, less than 13 mm, less than 14 mm, less than 15 mm, less than 16 mm, less than 17 mm, less than 18 mm, less than 19 mm, less than 20 mm, less than 21 mm, less than 22 mm, less than 23 mm, less than 24 mm, less than 25 mm, less than 26 mm, less than 27 mm, less than 28 mm, less than 29 mm, less than 30 mm, less than 31 mm, or less than 32 mm. Most preferably, the tube 1 has a diameter of less than 10 mm or less than 20 mm.

Preferably, the tube 1 has a wall thickness of less than 100 μm, less than 150 μm, less than 200 μm, less than 250 μm, less than 300 μm, less than 350 μm, less than 400 μm, less than 450 μm, less than 500 μm, less than 600 μm, less than 700 μm, less than 800 μm, less than 900 μm, less than 1 mm, less than 1.5 mm, less than 2 mm, less than 2.5 mm, less than 3 mm, less than 3.5 mm, less than 4 mm, less than 4.5 mm, less than 5 mm. Most preferably, the tube 1 has a wall thickness of less than 250 μm or less than 500 μm.

Preferably, the tube 1 has a length of less than 10 cm, less than 20 cm, less than 30 cm, less than 40 cm, less than 50 cm, less than 60 cm, less than 70 cm, less than 80 cm, less than 90 cm, less than 100 cm.

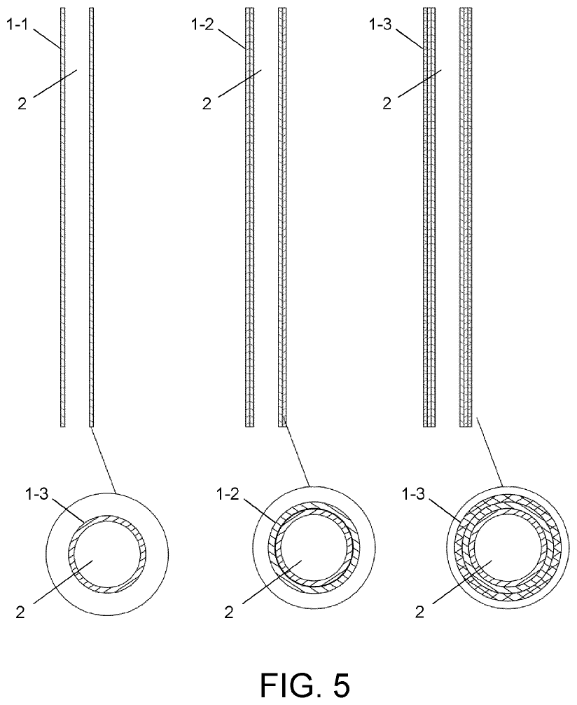

With reference to FIG. 5, the tube 1 may be single-layered 1-1, double-layered 1-2 or multi-layered 1-3. The tube 1 may comprise more than one layer of material or the inner surface of the tube 1 may be treated with an impermeable layer or lined an impermeable film or foil.

The tube 1 may be made from any natural or artificial materials, such as waxes, wood hollow stems of plants, glass, grain, plastic, metal, paper polymer and biopolymer type, plastic, polyolefin (including polyethylene and polypropylene), polystyrene, polyester (including polyethylene terephthalate, polyethylene terephthalate glycol-modified, polybutylene terephthalate, and polylactic acid), Coex, polycarbonate, polyvinyl chloride, acrylonitrile butadiene styrene, ethylene-vinyl alcohol copolymer, polyacrylamide, fluoropolymer (including polytetrafluoroethylene), polyamide (including as aramid fibers and nylon), polyoxymethylene, acrylic, carbon, coconut, pulp, algae, bamboo, cellulose and/or other inorganic or organic, quickly and slowly degradable materials. Organic materials may require the wall thickness of the tube 1 to be greater than for synthetic materials due to the need for greater strength, while the other parameters are identical. In another embodiment, the inner surface of the tube 1 which is in contact with the liquid preparation 5 may be treated by coating, impregnating, or soaking the material with an impermeable layer, or the inner surface of the tube 1 which is in contact with the liquid preparation 5 may be lined with an impermeable film or foil. As an example, if cardboard or wooden tubes are used, the inner surface of the tube 1 which is in contact with the liquid preparation 5 may be treated with an impermeable layer or lined with an impermeable film or foil to ensure its impermeability. In another embodiment, the outer surface of the tube 1 may be treated by coating, impregnating, or soaking the material with an impermeable layer, or the outer surface of the tube may be lined with an impermeable film or foil. In another embodiment, a tube made of an impermeable material may be inserted into another tube of any material to form the multi-layered tube 1-3.

The choice of material of the tube 1 and/or the coating may depend on the conditions required to store the liquid preparation 5.

The material of the tube 1 and/or the coating on the inner surface of the tube 1 may also decrease the flow rate of the liquid preparation 5 from a part of the lumen 2 to the plant substrate.

The outer surface of the tube 1 may be also adapted to the needs of press, marketing, design, functionality, plant protection, ecology, safety, users, as well as legal requirements.

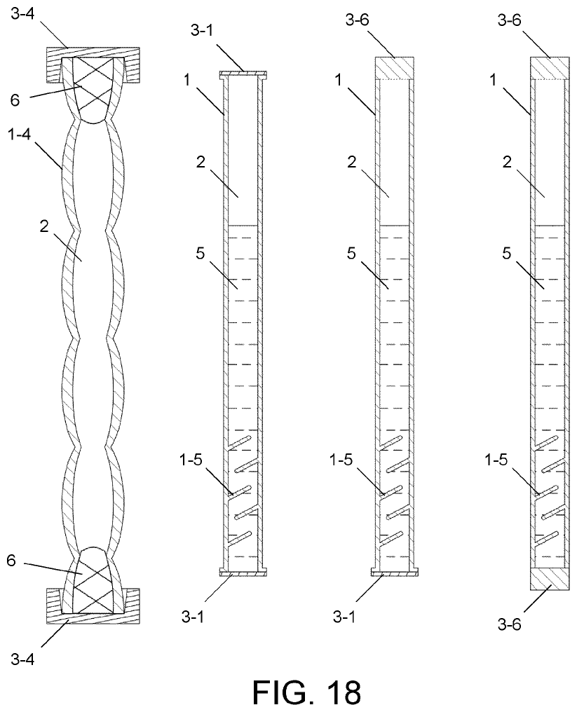

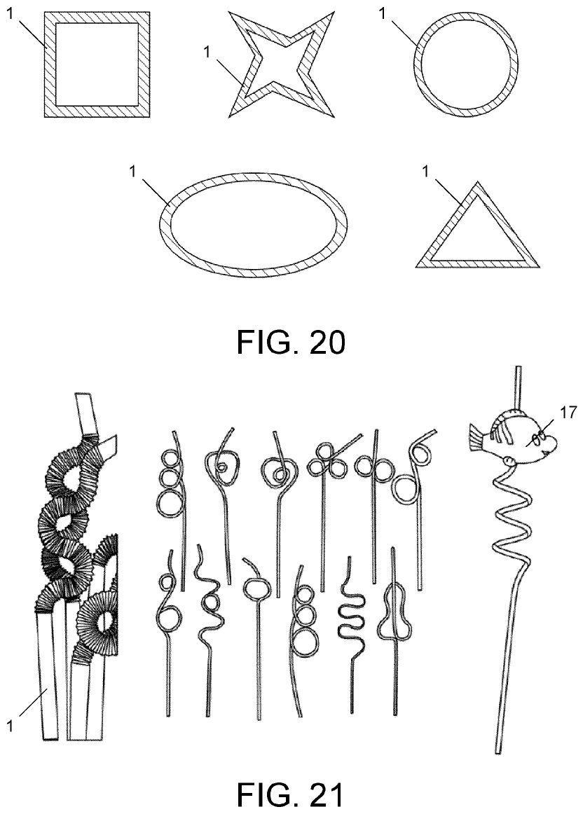

With reference to FIGS. 18, 20, 21 and 22, the shape of the tube 1 is variable depending on the desired flow rate of the liquid preparation 5. The tube 1 or a part of the tube 1 may be bent, extendable or twisted with accordion ribs or straight, longer or shorter, wider or narrower, and may have of cross-section of any shape, such as circular, elliptical, triangular, polygonal, or star-shaped. The tube 1 or a part of the tube 1 may comprise distortions in the shape of the tube 1-4 to allow for easier positioning of the flow control element 6. Preferably, the cross-section of the tube 1 is circular.

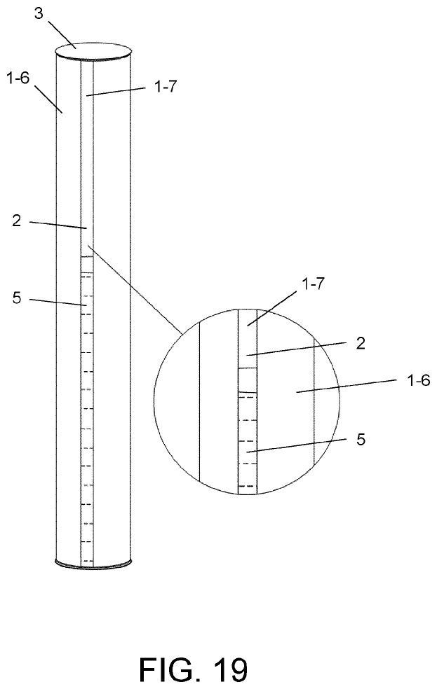

With reference to FIG. 19, the tube 1 may be of varied colour or combination of colours, as well as varied transparency. This variability affords the device with a wide range of possibilities related to storage, safety, efficiency, application, durability of preparations and marketing.

The tube 1 may be made of transparent 1-7, translucent 1-7 and/or opaque 1-6 material. In one embodiment, the tube 1 may be made of transparent or translucent material 1-7, or part of the tube 1 be made of transparent or translucent material 1-7, to permit the user to visualise the level of liquid preparation 5 in the lumen 2 of the tube 1. In another embodiment, the tube 1 may be made of opaque material 1-6, thereby preventing the passage of sunlight or another light source into the lumen 2 of the tube 1, which preserves the liquid preparation 5 if it is photoliable.

For liquid preparations 5 which are photosensitive and/or thermostable preparations, the use of dark shades of black, grey, brown, blue, purple, or red is preferably. Whilst for liquid preparations 5 which are photostable and/or thermolabile, lighter shades and more reflective colours are preferable.

The colour of the device may also act as an attractant and/or repellent for insects. As an example, yellow and orange colours may attract the largest number of various insects harmful to the plant, but repel flies, while blue attracts flies and repels mosquitoes. Depending on the target insect, other colours such as blue, red, green and white may be applied to the outside of the device.

In one embodiment of the invention, the tube 1 further comprises a mixing element 7 to mix the liquid preparation 5 in the tube 1 if settling occurs due to standing. Preferably, the mixing element 7 is an inert material.

The inert material may be made from any inert material, such as sand, bentonite, glass, kaolin, clay, talc and other natural materials, and/or plastic and other polymers with similar characteristics.

In one embodiment of the invention, the tube 1 further comprises a porous material 9.

In one embodiment of the invention, the tube 1 is a prebiotic for microorganisms and/or the tube 1 is impregnated or coated with a prebiotic. The prebiotic may extend the usability and/or shelf life of the device as the microorganisms feed on this type of tube 1. When the liquid preparation 5 flows from a part of the lumen 2 to the plant substrate, the prebiotic feed the microflora present in the plant substrate and thus affects the regeneration and durability of the substrate.

With reference to FIG. 18, in one embodiment of the invention, the tube 1 may comprise an obstacle 1-5 on the inner surface of the tube 1 which protrudes into the lumen 2 to reduce the flow rate of the liquid preparation 5. The ends of the tube 1 may be sealed with a closure 3, and in doing so channels may be formed around the obstacle 1-5 to reduce the flow rate of the liquid preparation 5.

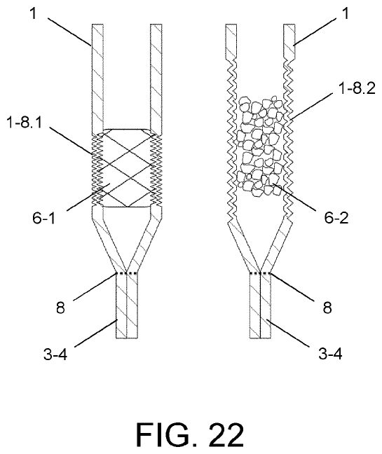

With reference to FIG. 22, in one embodiment of the invention, the tube 1 further comprises an extendable part 1-8 with accordion ribs, and wherein the flow control element 6 is positioned in the extendable part 1-8.

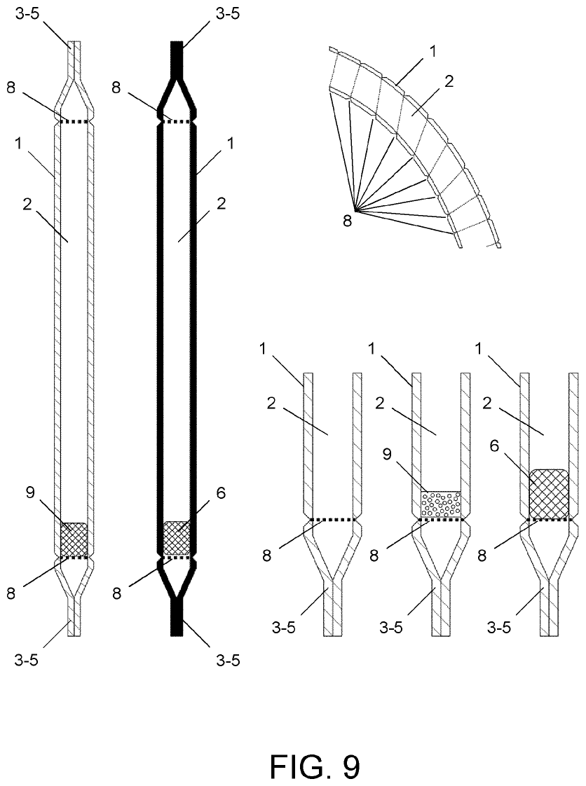

With reference to FIG. 9, in one embodiment of the invention, the tube 1 further comprises a score line 8, or more than one score lines 8, between the first end and/or the second end and the flow control element 6 which structurally weakens the tube 1 and permits the tube 1 to be broken.

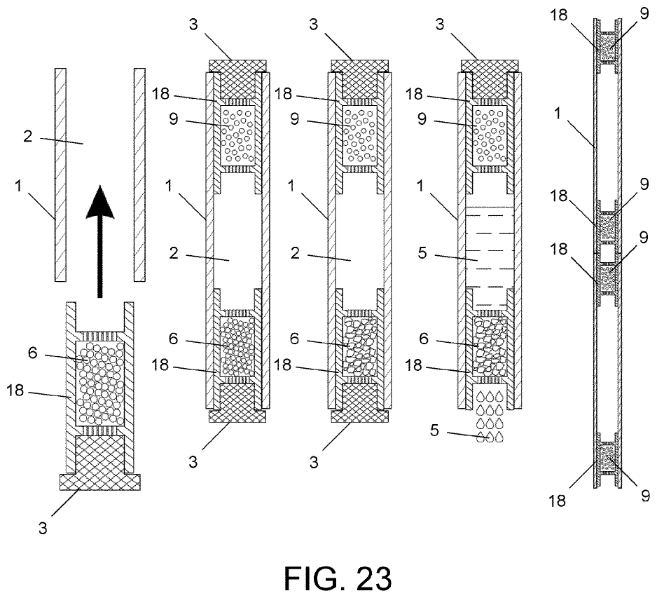

With reference to FIG. 23, in one embodiment of the invention, the closure 3 and/or the flow control element 6 are contained in a cartridge 18 which is inserted into the lumen 2 of the tube 1 at the first and/or second end. In embodiments wherein the cartridge 18 only contains a flow control element 6, and not a closure 3, the insertion of the cartridge 18 activates the device by breaking the closure 3 on the end of the tube 1 which permits the liquid preparation 5 to flow from the part of the lumen 2 through the cartridge 18 to the plant substrate. In embodiments wherein the cartridge 10 contains the closure 3 and the flow control, the cartridge 18 may serve as a fastener on the first and/or second ends of the tube 1.

The cartridge 18 may further comprise a porous material 9. As such, the porous material 9 does not shrink when inserting into the tube 1.

The cartridge 18 may also support the modular assembly of tubes 1.

The advantage of the cartridge 18 is that it can be prepared so that it can be pushed deeper into the tube 1 with minimal pressure. The cartridge 18 also provides strength to the device and supports the continuation of the device.

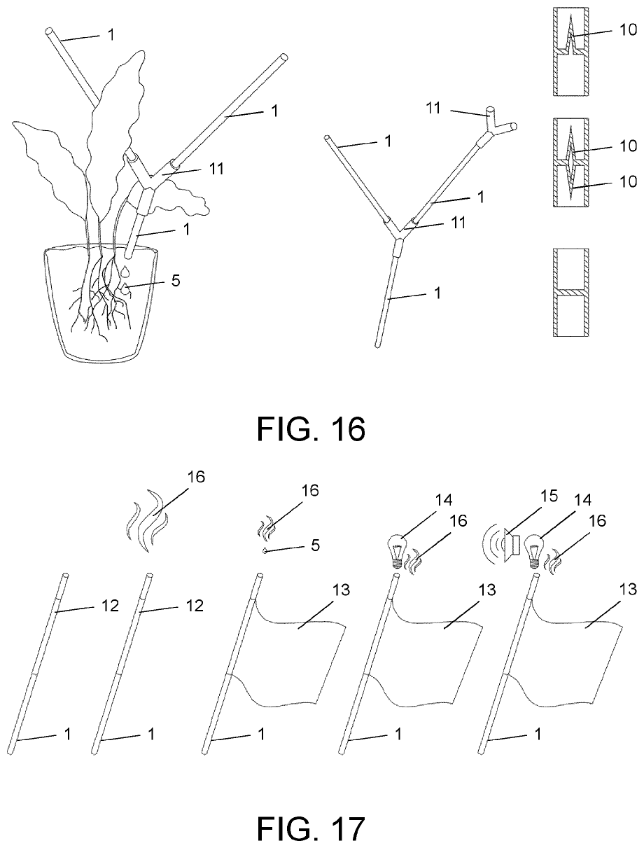

With reference to FIG. 16, in a further embodiment of the invention, the device comprises a modular assembly of tubes 1 using a connector 11. The tubes 1 may be assembled together to each other using single-leg or multi-leg connector 11. The connector 11 may comprise a drilling element 10 on one or both sides to conduct the liquid preparation 5 from the upper tube 1 to the lower tube 1. The connectors 11 may serve to facilitate the work of applying the device, but also to support the development of the plant. The connectors 11 can also be used as a decorative effect.

### The Flow Control Element

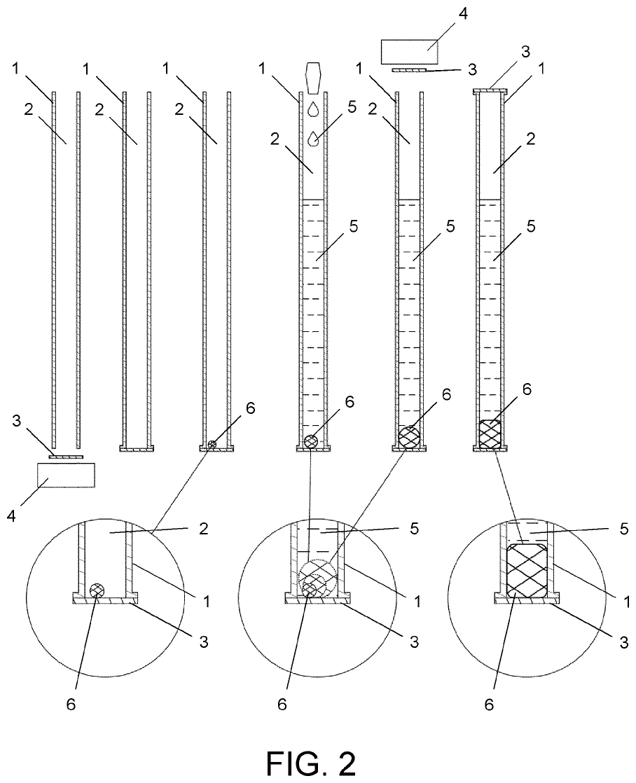

With reference to FIGS. 2 to 4, the tube 1 of the invention comprises a flow control element 6 in the lumen 2 which, when contacted with a liquid preparation 5, absorbs liquid and swells to reduce the flow rate of the liquid preparation 5 from a part of the lumen 2 to the first end. Preferably, during when the tube 1 is filled with the liquid preparation 5, when contacted with a liquid preparation 5, the flow control element 6 begins to swell. In one embodiment, the flow control element 6 swells to partially fill the cross-section of the lumen 2 of the tube 1. In another embodiment, the flow control element 6 swells to completely fill the cross-section of the lumen 2 of the tube 1.

Preferably, the flow control element 6 is positioned in the lumen 2 adjacent to the first and/or second end of the tube 1.

Preferably, the flow control element 6 retains the liquid preparation 5, but does not filter the active substance of the liquid preparation 5 to an extent that significantly lowers its concentration or weakens its action.

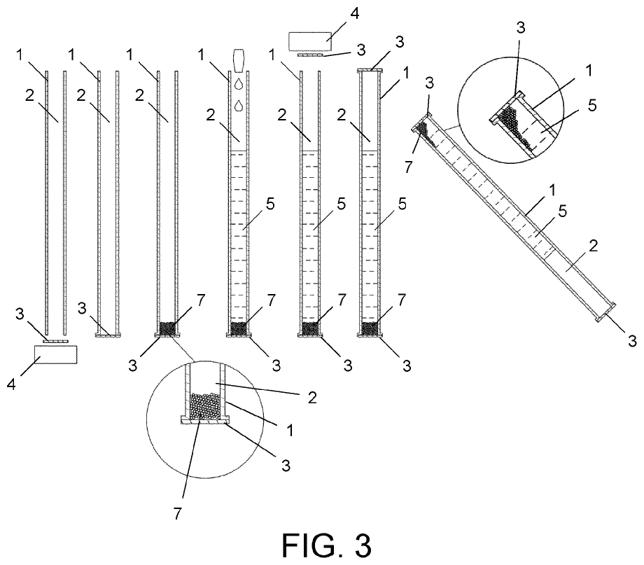

With reference to FIG. 3, in embodiments of the invention where the flow control element 6 has a lower swelling capacity and swells to partially fill the cross-section of the lumen 2 of the tube 1, the flow control element 6 is able to move in the lumen 2 of the tube 1 to reduce the flow rate of the liquid preparation 5 from a part of the lumen 2 to the first end and/or to mix the liquid preparation 5 in the tube 1 if settling occurs due to standing.

With reference to FIG. 2, in embodiments of the invention where the flow control element 6 swells to completely fill the cross-section of the lumen 2 of the tube 1, the flow control element 6 may further prevent uncontrolled leakage of liquid from the device once it is activated.

In one embodiment, the device of the invention comprises more than one flow control element 6, more than two flow control elements 6, more than three flow control elements 6, more than four flow control elements 6, or more than five flow control elements 6.

The one or more, two or more, three or more, four or more, or five or more flow control elements 6 may be of the same or different characteristics and sizes.

The flow control element 6 may be made of any hydrophilic and hydrophobic material, such as natural and/or synthetic polymers, sodium and potassium polyactylate, gelatin, agar, starch, cellulose, nanomaterials, waxed sand, various mineral sand, bentonite, kaolin, clay, talc, plastic, sponges, fibers, and/or or organic components of plant or animal origin. The flow control element 6 may also comprise other materials which are less capable of swelling, as well as powdered materials or inert materials.

In a preferred embodiment of the invention, the flow control element 6 is a hydrogel and/or an organic absorber. The hydrogel may be made from one or more natural polymers, synthetic monomers and/or synthetic polymers.

The hydrogel may be made from a natural polymer, such as sodium alginates, cellulose, bacterial nanocellulose, gelatin (type A and type B) and other protein, starch, chitin, chitosan, D-glucose, Glucomannan, galactomannan, agarhyaluronic acid, heparin, fibrin, pectin, natural gums, gum arabic, β-glucan or others, or derivatives thereof.

The hydrogel may be made from a synthetic polymer, such as an acrylic polymer, a vinyl polymer, poly(ethylene glycol), polyhydroxyalkanoates, polylactide, polycaprolactone, polyurethane, poly(propylene glycol), poly(vinyl pyrrolidone), sodium polyacrylate, potassium polyacrylate, acrylate polymers or others, or copolymers thereof. Most preferably, the hydrogel is sodium polyacrylate and/or potassium polyacrylate.

In one embodiment of the invention, the flow control element 6 is a prebiotic for microorganisms. The prebiotic may extend the usability and/or shelf life of the device as the microorganisms feed on this type of flow control element 6. When the liquid preparation 5 flows from a part of the lumen 2 to the plant substrate, the prebiotic feed the microflora present in the plant substrate and thus affects the regeneration and durability of the substrate.

The organic absorber may be made from any material, such as gelatin, agar, starch, cellulose, nanomaterials, waxed sand, various mineral sand, bentonite, kaolin, clay, talc and others, plastic particles, sponges and/or fibers.

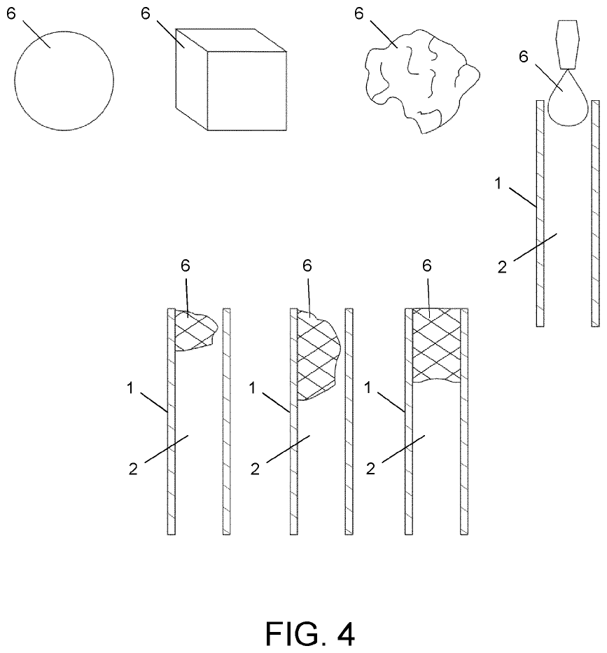

With reference to FIG. 4, the flow control element 6 can be provided in various forms or shapes. The flow control element 6 is preferably provided as a prepared shape, such as spherical, cubed, cylindrical, ellipsoidal, triangular, quadrangular, coned, and the like, as well as star-shaped. Most preferably, the flow control element 6 is spherical. In an another embodiment, the flow control element 6 is provided as an undefined shape. In an another embodiment, the flow control element 6 is provided in the form of a gel. The flow control element 6 in the form of a gel may then be injected into the lumen 2 of the tube 1. The flow control element 6 may then be inserted into the lumen 2 of the tube 1 close to or next to the first end of the tube 1. After insertion, the flow control element 6 may remain attached to the inner surface of the tube 1 and when contacted with a liquid preparation 5, absorbs liquid and swells to partially or completely fill the cross-section of the lumen 2 of the tube 1.

The advantage of using a flow control element 6 which swells in comparison to elements such as filters and similar porous materials that have defined dimensions is that, when in contact with the liquid preparation 5, it absorbs liquid and swells to partially or completely fill the lumen 2 of the tube 1. As such, it is possible to use a flow control element 6 of various forms or shapes, and also a tube 1 with a cross-section of any shape, such as circular, elliptical, triangular, polygonal, or star-shaped.

The dimensions of the flow control element 6 will depend on the characteristics of the liquid preparation 5 with which the device is filled and on the amount liquid the flow control element 6 can absorb. The flow control element 6 before swelling preferably has a diameter of less than 0.5 mm, less than 1 mm, less than 1.5 mm, less than 2 mm, less than 2.5 mm, less than 3 mm, less than 3.5 mm, less than 4 mm, less than 4.5 mm, less than 5, less than 10, less than 15 mm, less than 20 mm, less than 25 or less than 30 mm. As an example, for a tube 1 with a diameter of up to 10 mm, the flow control element 6 has a diameter of less than 3.5 mm. Preferably, the flow control element 6 has a diameter of 1 to 3 mm, in particular 1 to 2.5 mm. As another an example, when the tube 1 of the invention has a diameter greater than 10 mm, the flow control element 6 has a diameter greater than 2.5 mm. After swelling, the dimensions of the flow control element 6 increase so that that the flow control element 6 partially or completely fills the cross-section of the lumen 2 of the tube 1. In embodiments where the flow control element 6 swells to completely fill the cross-section of the lumen 2 of the tube 1, the flow control element 6 after swelling has the same diameter as the cross-section of the lumen 2 of the tube 1. The flow control element 6 may then further swell and increase in size along the length of the lumen 2 of the tube 1.

The flow control element 6 may of any colour.

With reference to FIG. 17, in another embodiment, the flow control element 6 may be impregnated or coated with a fragrant substance 16 or combination of fragrant substances 16. The fragrant substance 16 or combination of fragrant substances 16 may act as attractants, repellents, and/or room fresheners. The fragrant substance 16 may be an artificial and/or natural substance. As an example, the fragrant substance 16 may refresh the space through the process of evaporation from the plant substrate. As another example, the fragrant substance 16 may be an essential oil, which, depending on the type, can stimulate its immunity, or cleanse it of pathogens and pests, but they do not necessarily have a stimulating effect. Various volatile compounds of microbiological origin, as well as vegetable turpentines, have a significant effect on the plant or on organisms which may affect the plant. As another example, the fragrant substance 16 may act as a repellent to pets, such as dogs, cats, rodents or rabbits, or other animals. The arrangement of several devices around the house may keep the pets away from plants or furniture etc. and prevent them from defecating on or damaging said plants or furniture. Fragrant substances 16 are incorporated into the flow control element 6 as needed during production.

### The Closure

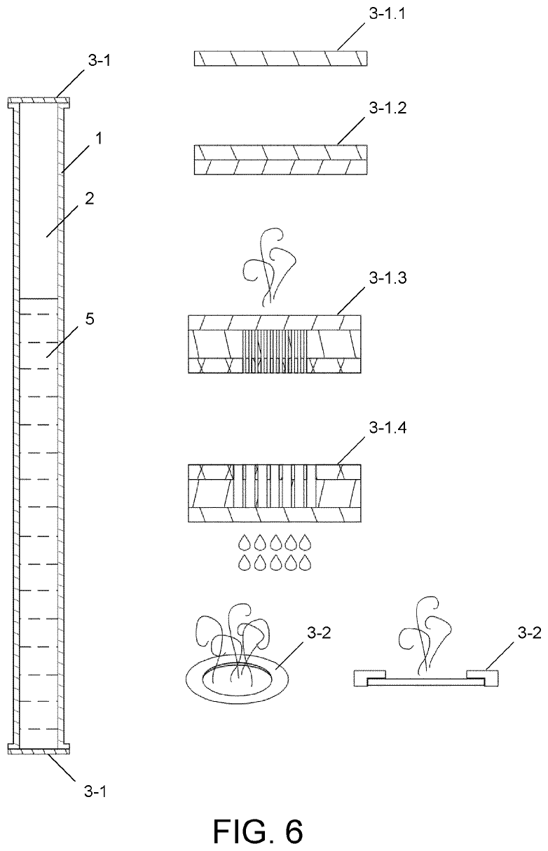

With reference to FIGS. 6 to 9, the tube 1 of the invention comprises a closure 3 at the first end. The tube 1 may further comprise a closure 3 at the second end.

The closure 3 at the first or second end may be a foil 3-1, a membrane 3-2, a cap, a plug 3-3 which is inserted into the lumen 2 of the tube 1 and/or a plug 3-4 which is pulled around the tube 1 at the ends. Alternatively, the walls of the tube 1 at the first or second end may be connected by external pressure on the wall of the tube 1 and bonded by means of ultrasound, heat and/or glue, or welded, to form the closure 3-5. Alternatively, the ends of the tube 1 may be sealed 3-6. The closure 3 must ensure hermetic sealing of the end of the tube 1. The closure 3 must also withstand the pressure caused by mechanical pressure on the device, as well as by the increase in pressure inside the tube 1 originating from the contents of the tube 1. The increase in pressure on the closures 3 occurs due to mechanical pressure on the tube 1, biological, chemical and biochemical influences due to the reaction processes of the contents and elements inside the tube 1, as well as temperature effects and the amount of air in the tubes 1. As such, the materials of the closure 3 and the tube 1 must be compatible so that there is no leakage due to the increase in pressure. The material of the tube 1 must also be compatible with the closure 3 intended to ensure a secure seal. The type of the closure 3 therefore also may depend on the intended material of the tube 1. Preferably, the type of the closure 3 represents solutions that are the easiest to apply by the user.

The closure 3 may be single-layered, double-layered or multi-layered.

The closure 3 may be coated with a water-resistant protection.

The closure 3 may be impermeable, permeable or vapour-permeable. An impermeable closure 3 does not allow liquid or air to pass through. A permeable closure 3 comprises a material that contains pores of a diameter that allows liquid and air to pass through. A vapour-permeable closure 3 comprises a material that contains pores of a diameter that only allows air to pass through but not liquid. A permeable or vapour-permeable closure 3 may comprise an impermeable outer layer that can be removed in order to activate the device and allow the passage of air and/or liquid to or from a part of the lumen 2 of the tube 1. The function of the permeable or vapour-permeable closure 3 may depend on the number and size of the pores. A permeable closure 3 at the first end may reduce the flow rate of the liquid preparation 5 from a part of the lumen 2 to the plant substrate. A vapour-permeable and permeable closure 3 at the second end may reduce the rate of entry of air into the lumen 2 of the tube 1 at the second end, and thus reduce the flow rate of the liquid preparation 5 from a part of the lumen 2 to the plant substrate.

Permeable or vapour-permeable closures 3 have the advantage that, when there is a possibility that liquid preparations 5 of fertilizers and pesticides create pressure, the pressure will be released through the pores of the closure 3.

In a preferred embodiment, the closure 3 is a vapour-permeable or permeable foil 3-1, membrane 3-2, plug 3-3 which is inserted into the lumen 2 of the tube 1 or plug 3-4 which is pulled around the tube 1 at the ends. A vapour-permeable 3-2 or permeable membrane 3-2 may be attached to the tube 1 by means of gluing, welding, that is, joining and fusing the two materials, as well as installing a removable cover that contains a built-in membrane 3-2.

With reference to FIG. 6, the closure 3 in the form of a foil 3-1 may be attached at the first or second end of the tube 1 by bonding the foil 3-1 to the device by pressing the foil 3-1 against the opening of the tube 1. Alternatively, the closure 3 in the form of a foil 3-1 may be attached at the first or second end of the tube 1 by heating the foil 3-1 with a heater, ultrasonically, glue, or some other method. Both approaches result in bonding or melting of adjacent materials, i.e. by gluing when the surfaces are united. In some embodiments, the closure 3 is made from the same material as the tube 1. In some embodiments, the closure 3 is multi-layered and is made from a material which is compatible to the material of the tube 1. Preferably, the foil 3-1 is made from aluminium, aluminium-polyethylene or polypropylene. As an example, for a tube 1 made from plastic, the closure 3 is preferably an impermeable compatible two-layer or multi-layer foil 3-1.2 which is inextricably bound to the device during melting. Alternatively, the closure 3 may be an impermeable single-layered foil 3-1.1. In order to activate the device, the closure 3 may be pierced using the drilling element 10. Alternatively, the foil may be vapour-permeable 3 -1.3 which comprises pores of a diameter that only allows air to pass through. The vapour-permeable foil 3 -1.3 may comprise a compatible bonding layer and/or an impermeable outer layer that can be removed in order to activate the device and allow the passage of air to a part of the lumen 2 of the tube 1. Alternatively, the foil may be permeable 3-1.4 which comprises pores of a diameter that allows liquid and air to pass through. The permeable foil 3-1.4 may comprise a compatible bonding layer and/or an impermeable outer layer that can be removed in order to activate the device and allow the passage of air and/or liquid to or from a part of the lumen 2 of the tube 1.

With reference to FIG. 6, the closure 3 may also be in the form of a membrane 3-2. Preferably, the closure 3 may be a vapour-permeable membrane 3-2 used for controlled air leakage to a part of the lumen 2 of the tube 1, which comprises an outer layer that can be removed in order to activate the device.

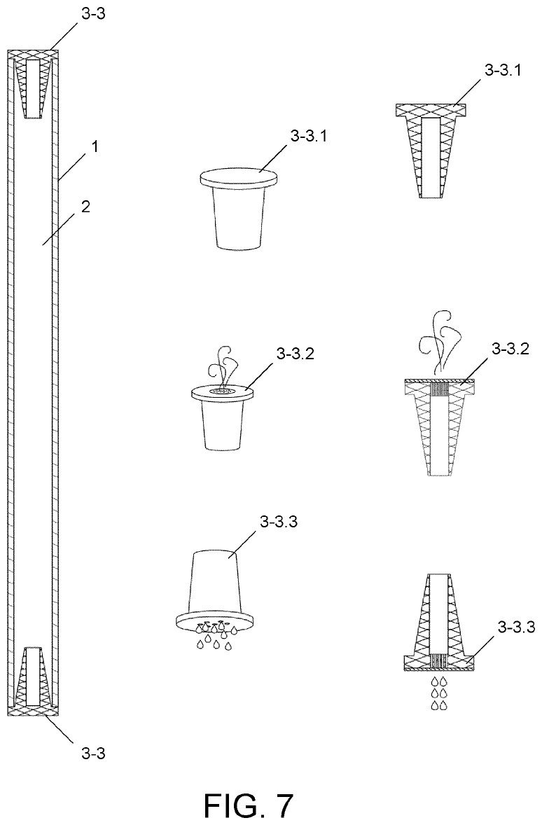

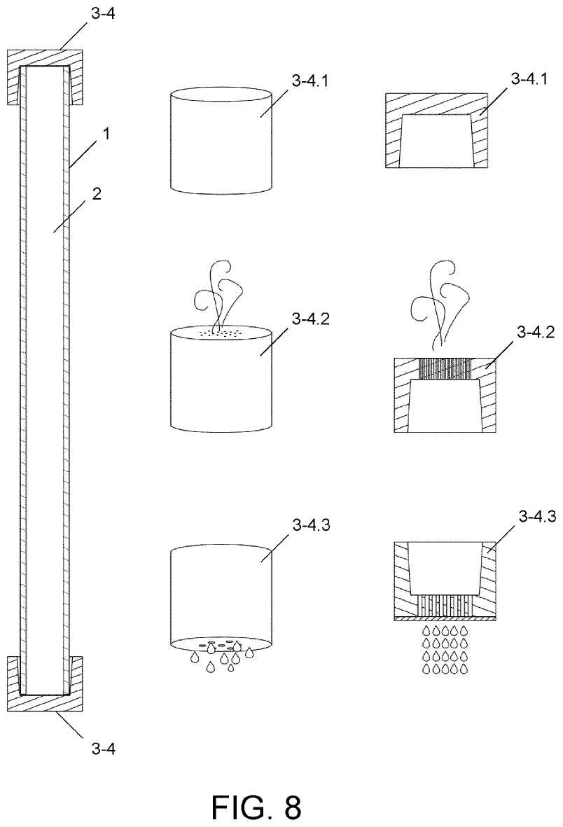

With reference to FIGS. 7 and 8, the closure 3 in the form of a plug 3-3 may be inserted into the lumen 2 of the tube 1 at the first or second end, or the plug 3-4 may be pulled around the tube 1 at the first or second end. The plug 3-3 or the plug 3-4 must ensure hermetic closure 3 with their shape, or additionally use a coating that would help, which is especially important for the packaging of tubes 1 whose production does not ensure machine precision. Preferably, the plug 3-3 or the plug 3-4 is conical in shape. The plug 3-3 may be a solid cross-section or hollow which is inserted into the lumen 2 of the tube 1 at the first or second end. The plug 3-3 may be impermeable 3-3.1, vapour-permeable 3-3.2 or permeable 3-3.3. Alternatively, the plug 3-4 may be hollow plug which is conical in shape, and where the walls of the plug 3-4 are tapered towards the top in order to wedge the tube 1, which is pulled around the tube 1 at the first or second end. The plug 3-4 may be impermeable 3-4.1, vapour-permeable 3-4.2 or permeable 3-4.3. A hollow plug 3-3 or the plug 3-4 has the advantage that it can be compressed enough not to tear the tube 1 during insertion, such as with thin-walled plastic tubes. A vapour-permeable or permeable plug 3-3 or plug 3-4 may further comprise an impermeable outer layer that can be removed in order to activate the device and allow the passage of air or liquid to a part of the lumen 2 of the tube 1.

With reference to FIG. 9, the closure 3-5 at the end of the tube 1 may be formed when the walls of the tube 1 are connected by external pressure on the wall of the tube 1 and bonded by means of ultrasound, heat and/or glue, or welded. In this embodiment, the tube 1 may comprise a score line 8 between the first end and the flow control element 6 and/or porous material 9 which structurally weakens the tube 1 and permits the tube 1 to be broken. Additionally or alternatively, the tube 1 may comprise a score line 8 between the second end and the flow control element 6 which structurally weakens the tube 1 and permits the tube 1 to be broken. The tube 1 may comprise more than one, more than two, more than 3, more than 4, more than 5, more than 6, more than 7, more then 8, more than 9, or more than 10 score lines 8.

Depending on the choice of closure 3 and/or activation method, once the device has been activated, the part of the closure 3 remaining may reduce the flow rate of the liquid preparation 5 from a part of the lumen 2 to the first end.

### The Drilling Element

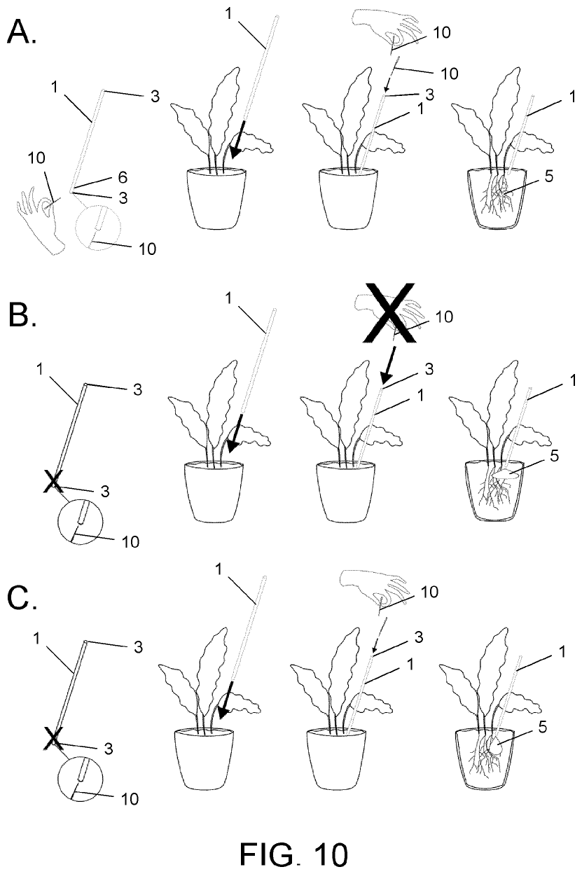

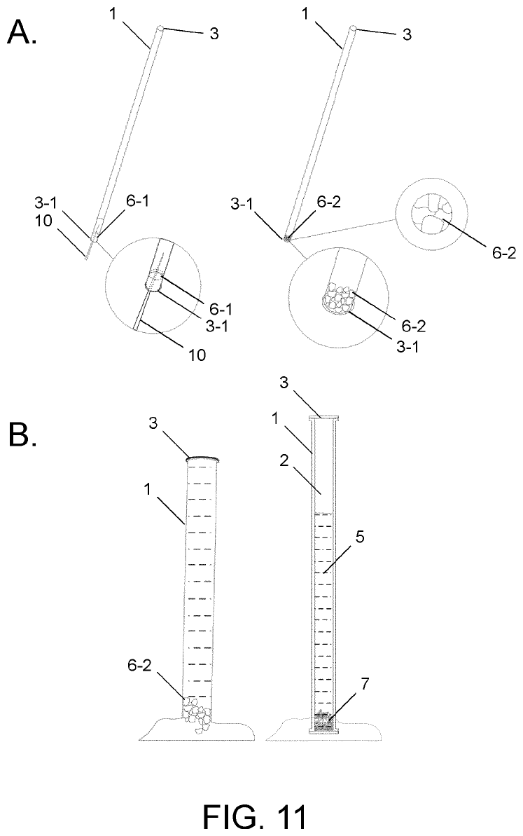

With reference to FIG. 10, in one embodiment of the invention, the device comprises a drilling element 10 to activate the device by piercing the closure 3 and the flow control element 6 at the first end of the tube 1 using the drilling element 10, inserting the first end of the tube 1 into the plant substrate, and then piercing the closure 3 and/or the flow control element 6 at the second end of the tube 1 using the drilling element 10 to permit the liquid preparation 5 to flow from the part of the lumen 2 to the plant substrate in a controlled manner. With reference to FIG. 11, piercing of the flow control element 6-1 using the drilling element 10 leads to the collapse of its polymer structure and fragmentation of the flow control element 6-2. As such, cracks are formed in the flow control element 6-2 through which the liquid preparation 5 is permitted to flow.

The drilling element 10 may be inserted into the end of the device during activation, or pre-installed on the device.

The drilling element 10 can be in the form of any shape. Preferably, the drilling element 10 is pointed in shape, but it can also be adapted for multiple purposes. Most preferably, the drilling element 10 is in the form of a toothpick. The length of the drilling element 10 is preferably such that the closure 3 and the flow control element 6 after swelling are simultaneously pierced. The diameter of the drilling element 10 may be adapted depending on the type of closure 3 and diameter of the tube 1. Preferably, the drilling element 10 is used in embodiments where the closure is made of foil 3-1. As shown in FIG. 11, when piercing the foil closure 3-1 using the drilling element 10, the diameter of the drilling element 10 may be such that it does not remove the foil 3-1 from the entire diameter of the end of the tube 1. Instead, when piercing the foil closure 3-1 using the drilling element 10, a part of the closure 3 being a ring of foil 3-1 remains at the end of the tube 1. The part of the closure 3 remaining may prevent the cracked flow control element 6-2 from falling out of the tube 1. The part of the closure 3 remaining may also reduce the flow rate of the liquid preparation 5 from a part of the lumen 2 to the first end.

In one embodiment of the invention, the drilling element 10 can be part of a casing, preferably wherein the casing is in the form of a cap and the drilling element 10 is contained inside the cap. This casing may limit potential contact between the user and the liquid preparation 5 when the device is activated using the drilling element 10.

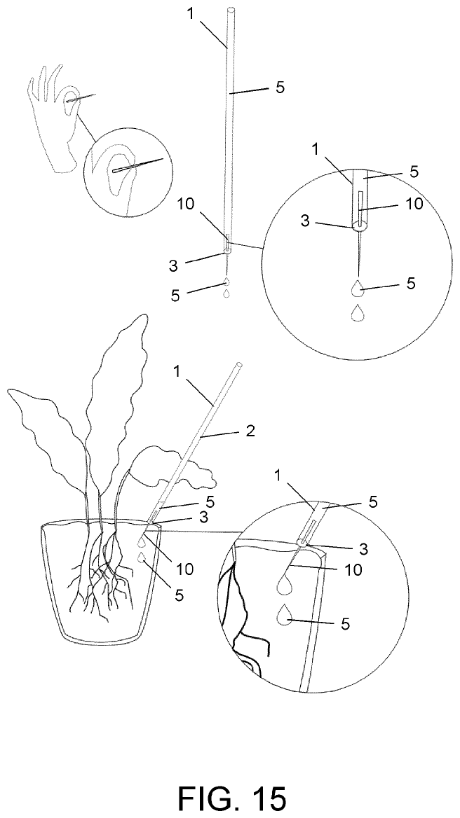

With reference to FIG. 15, the drilling element 10 may have the ability to capillary, or in some other way, conduct the liquid preparation 5 into the plant substrate when the end of the tube 1 to which the drilling element 10 is placed is inserted into a plant substrate.

The drilling element 10 may strengthen the device and makes it easier for the user to insert the end of the tube 1 to which the drilling element 10 is placed into a plant substrate, as well as makes it easier for the user to position the device at the desired angle.

The drilling element 10 may be made from any material. Preferably, the drilling element 10 is made from starch, cereal, pasta, spaghetti, bamboo, algae, coconut, other organic components, wood, metal, plastic, natural or artificial polymers, and/or compressed fibres such as those used in felt-tip pens. When such materials are used, the drilling element 10 may be left in the plant substrate to serve as organic fertilizer, repellent and/or food for the microorganisms present.

In one embodiment of the invention, the drilling element 10 is a prebiotic for microorganisms. The prebiotic may extend the shelf life of the device as the microorganisms feed on this type of drilling element 10. The prebiotic may prolong usability of the device after device is empty. When the liquid preparation 5 flows from a part of the lumen 2 to the plant substrate, the prebiotic feed the microflora present in the plant substrate and thus affects the regeneration and durability of the substrate.

In one embodiment of the invention, the drilling element 10 may act as a repellent for soil pests.

### The Modifying Element

With reference to FIGS. 17 and 21, in one embodiment of the invention, the device comprises a modifying element on the outer surface of the tube 1.

The modifying element may be an adhesive 12, a sticker 12, a paper 12, a foil 12, a flag 13, a light source 14, a sound source 15, an electric source and/or a decoration 17. The modifying elements described can be used separately or combined to achieve a better-desired effect.

The adhesive 12 may have a role in immobilising insects that are harmful to plants or humans upon contact. Such insects are usually peat and other flies, wasps, moths, bed bugs, mosquitoes, midges and others. Adhesives 12 are applied directly to outer surface of the tube 1, or they are applied to a sticker 12 which is placed on the outer surface of the tube 1.

The light source 14 may be placed on the outer surface of the tube 1 to act as an attractant and/or repellent for insects and/or pets or other animals. The light source 14 can be provided in various forms or with various characteristics, such as size, shape, colour, intensity, as well as being a constant or flashing light, which is variable depending on the desired outcome. The light source 14 may have a photovoltaic and/or a constant and rechargeable current source that would increase the effectiveness of the device, especially at night, but also minimally illuminate the space. The light source 14 may further contain a sensor to be activated on movement by such insects, pets or other animals and/or people.

The sound source 15 may be placed on the outer surface of the tube 1 to act as an attractant and/or repellent for insects and/or pets or other animals. The sound source 15 may be a flashing and/or continuous sound of low, high or ultrasound frequencies, and may contain a sensor to be activated on movement by such insects and/or pets or other animals. Preferably, the sound source 15 is an ultrasound.

The electric source may be placed on the outer surface of the tube 1 to act as attractants and/or repellents for insects and/or pets or other animals and/or to kill insects. The electric source may throw a spark at insects and kill them or sting pets if they touch the device.

The modifying element may be impregnated with or soaked in a fragrant substance 16 or combination of fragrant substances 16. The fragrant substance 16 or combination of fragrant substances 16 may act as an attractant and/or repellent for insects, and/or a room freshener. The fragrant substance 16 may be an artificial and/or natural substance. As an example, the fragrant substance 16 may refresh the space through the process of evaporation from the plant substrate. As another example, the fragrant substance 16 may be an essential oil, which, depending on the type, can stimulate its immunity, or cleanse it of pathogens and pests, but they do not necessarily have a stimulating effect. As another example, the fragrant substance 16 may act as a repellent to pets, such as dogs, cats, rodents or rabbits, or other animals. The arrangement of several devices around the house may keep the pets away from plants or furniture etc. and prevent them from defecating on or damaging said plants or furniture. Fragrant substances 16 are incorporated into the modifying element as needed during production.

In another embodiment, the modifying element may be impregnated with or soaked in a nutrient substance or combination of nutrient substances. The nutrient substance or combination of nutrient substance may act as an attractant and/or repellent for insects and/or support the life of entomopathogens. The nutrient substance may be an artificial and/or natural substance, such as alcohol, yeast, fruit scent, sugar water, honey, nectar, pheromones and/or others.

Using a combination of modifying elements on the outer surface of the tube 1, such as a modifying element soaked in a fragrant substance 16 or a nutrient substance with a light source 14 of adequate colour or sound source 15, contributes to a more efficient operation of the device and protection of the plants in the plant substrate from harmful insects. The same principle is applicable to mosquitoes that often hide in flowers. The device of the invention can be used only for the purpose of protecting plants, without the need to feed the flowers.

The modifying element may be of varied colour or combination of colours. The colour of may also act as an attractant and/or repellent for insects. As an example, yellow and orange colours may attract the largest number of various insects harmful to the plant, but repel flies, while blue attracts flies and repels mosquitoes. Depending on the target insect, other colours such as blue, red, green and white may be applied to the outside of the device.

The modifying element which is attached on the outer surface of the tube 1 by means of pressure or heat may have an effect on the shaping and deformation the inner wall surface of the tube 1. As a result, the diameter of the tube 1 may vary, which may increase or reduce the flow rate of the liquid preparation 5 from a part of the lumen 2 to the plant substrate. Depending on the material from which the device is made, the modifying element may be attached on the outer surface of the tube 1 by applying pressure with or without heating, or ultrasonically when they are shaped and/or stuck due to high friction. The modifying element may be attached on any part of the device, and if attached at the first or second end of the tube 1, the narrowing of the diameter of the tube 1 should be limited such that it does not allow easy clogging when inserting the device into the plant substrate. The deformation of the tube 1 when attaching the modifying element may serve to hold the flow control element 6 in the lumen 2 of the tube 1 in a certain position.

### The Liquid Preparation

The liquid preparation 5 of the invention is a fertilizer, a pesticide and/or a fragrant substance 16.

The fertilizer may be any suitable material, such as an organic fertilizer, a mineral fertilizer, an organo-mineral fertilizer, a plant strengthener, a plant stimulator, a phytohormone, a microbial fertilizer, a microbial metabolite, a biofertilizer, an enzyme, a soil improver and/or an essential oil.

The pesticide may be any suitable material, such as a biopesticide, a microbial pesticide, a synthetic pesticide, an organic pesticide, an adjuvant, a disinfectant, hydrogen peroxide and/or liquid ozone. For example, the pesticide may be an arthropod, an insect and/or a nematode.

The fragrant substance 16 may any material, such as an essential oil, pheromone, microbial volatile organic compounds (MVOCs), volatile organic compounds (VOCs) and/or a synthetic fragrant substance.

The concentration of the fertilizer will depend on the application, but preferably, the concentration of the fertilizer used in the device is such that its direct application will not lead to wilting of the plant on which it is applied.

Preferably, the liquid preparation 5 is at a ready-to-use concentration.

Preferably, the concentration of the liquid preparation 5 is less than 100 ml per litre, less than 90 ml per litre, less than 80 ml per litre, less than 70 ml per litre, less than 60 ml per litre, less than 50 ml per litre, less than 40 ml per litre, less than 30ml per litre, less than 20ml per litre, less than 10 ml per litre, less than 9 ml per litre, less than 8 ml per litre, less than 7 ml per litre, less than 6 ml per litre, less than 5 ml per litre, less than 4 ml per litre, less than 3 ml per litre, less than 2 ml per litre, less than 1 ml per litre, less than 0.9 ml per litre, less than 0.8 ml per litre, less than 0.7 ml per litre less than 0.6 ml per litre, less than 0.5 ml per litre, less than 0.4 ml per litre, less than 0.3 ml per litre, less than 0.2 ml per litre or less than 0.1 ml per litre. Preferably, the concentration of the fertilizer is at a dilution of between 0.5 ml per litre and 10 ml per litre. A higher dilution may be used for phytohormones, some vitamins and other high reactive metabolites and products.

Preferably, the concentration of the active ingredient in the liquid preparation 5 is less than 100 g per litre, less than 90 g per litre, less than 80 g per litre, less than 70 g per litre, less than 60 g per litre, less than 50 g per litre, less than 40 g per litre, less than 30 g per litre, less than 20 g per litre, less than 10 g per litre, less than 9 g per litre, less than 8 g per litre, less than 7 g per litre, less than 6 g per litre, less than 5 g per litre, less than 4 g per litre, less than 3 g per litre, less than 2 g per litre, less than 1 g per litre, less than 0.9 g per litre, less than 0.8 g per litre, less than 0.7 g per litre less than 0.6 g per litre, less than 0.5 g per litre, less than 0.4 g per litre, less than 0.3 g per litre, less than 0.2 g per litre, less than 0.1 g per litre. Preferably, the concentration of the fertilizer is at a dilution of between 0.5 g per litre and 10 g per litre. A higher dilution may be used for phytohormones, some vitamins and other high reactive metabolites and products.

Preferably, the concentration of the liquid preparation 5 in the device is such that its direct application will not lead to wilting of the plant on which it is applied. Depending on the concentration of the liquid preparation 5 and the needs of different plants for preparations, the discharge speed of the device may be regulated, which avoids the very possibility of any damage to the plant.

With reference to FIG. 17, in one embodiment, the liquid preparation 5 may be a fragrant substance 16 or combination of fragrant substances 16. In another embodiment, the liquid preparation 5 in the form of a fertilizer or a pesticide may be impregnated with a fragrant substance 16 or combination of fragrant substances 16. The fragrant substance 16 or combination of fragrant substances 16 may act as attractants, repellents, and/or room fresheners. The fragrant substance 16 may be an artificial and/or natural substance. As an example, the fragrant substance 16 may refresh the space through the process of evaporation from the plant substrate. As another example, the fragrant substance 16 may be an essential oil, which, depending on the type, can stimulate its immunity, or cleanse it of pathogens and pests, but they do not necessarily have a stimulating effect. As another example, the fragrant substance 16 may act as a repellent to pets, such as dogs, cats, rodents or rabbits, or other animals. The arrangement of several devices around the house may keep the pets away from plants or furniture etc. and prevent them from defecating on or damaging said plants or furniture. Fragrant substances 16 are incorporated into the liquid preparation 5 as needed during production.

### Activation and Application of the Device

The present invention also provides a method of activating the device of the invention, wherein the method comprises mechanically deforming a part of the closure 3 and a part of the flow control element 6 to permit the liquid preparation 5 to flow from the part of the lumen 2 to the plant substrate.

Specific methods of activation of the device are now described.

In one embodiment of the invention, the device is activated by removing the closure 3 or removing a part of the closure 3. If the closure 3 is a multi-layered closure 3, the device may be activated by removing one or more layers of closure 3. As an example, in an embodiment when the flow control element 6-1 is damaged due to the pressure with the walls of the tube 1, the device may be activated by removing the closure 3 or removing a part of the closure 3 without the need to further deform the flow control element 6-2.

With reference to FIGS. 10 and 11, in one embodiment of the invention, the device is activated by piercing the closure 3 and/or the flow control element 6 using the drilling element 10. FIG. 10a shows the method of activating the device by piercing the closure 3 and the flow control element 6 at the first end of the tube 1 using the drilling element 10, inserting the first end of the tube 1 into the plant substrate, and then piercing the closure 3 and/or the flow control element 6 at the second end of the tube 1 using the drilling element 10 to permit the liquid preparation 5 to flow from the part of the lumen 2 to the plant substrate in a controlled manner. FIG. 10b shows a device which does not contain a flow control element 6 at the first end of the tube 1, such that following piercing of the closure 3 at the first end of the tube 1 using the drilling element 10 and inserting the first end of the tube 1 into the plant substrate, but not piercing the closure 3 at the second end, the liquid preparation 5 flows from the part of the lumen 2 to the plant substrate by capillary forces. FIG. 10c shows a device which does not contain a flow control element 6 at the first end of the tube 1, such that following piercing of the closure 3 at the first end of the tube 1 using the drilling element 10, inserting the first end of the tube 1 into the plant substrate, and then piercing the closure 3 and/or the flow control element 6 at the second end of the tube 1, the liquid preparation 5 flows from the part of the lumen 2 to the plant substrate to flood the roots of the plant. The principles of activating the device shown in FIGS. 10a, 10b and 10c apply the device of the invention with any form of closure 3 and method of activation.

Piercing of the flow control element 6-1 leads to the collapse of its polymer structure and fragmentation of the flow control element 6-2. As such, cracks are formed in the flow control element 6-2 through which the liquid preparation 5 is permitted to flow. The cracked the flow control element 6-2 may move freely in the lumen 2 of the tube 1, thereby preventing the first end of the tube 1 from clogging and preventing the flow of the liquid preparation 5 when the first end of the tube 1 is inserted into the plant substrate.

With reference to FIG. 15, the drilling element 10 may conduct the liquid preparation 5 into the plant substrate when the end of the tube 1 to which the drilling element 10 is placed is inserted into a plant substrate. With reference to FIG. 12, in one embodiment of the invention, the device is activated by applying pressure to the outer surface of the tube 1 at the first end, and close to where the flow control element 6-1 is positioned, to break the closure 3 and deform the flow control element 6-2. Preferably, the tube 1 is made of plastic, or other recyclable or organic material with similar characteristics, and has a wall thickness sufficient for the tube 1 to be flexible.

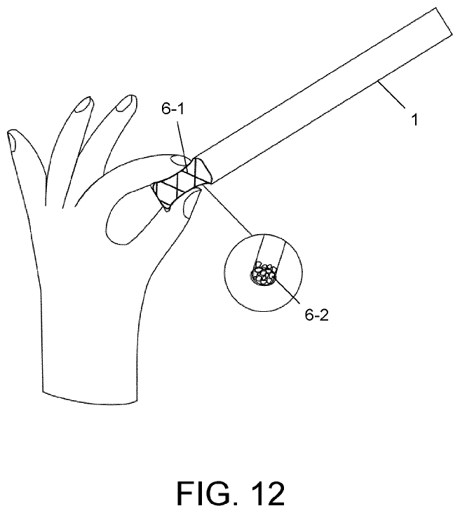

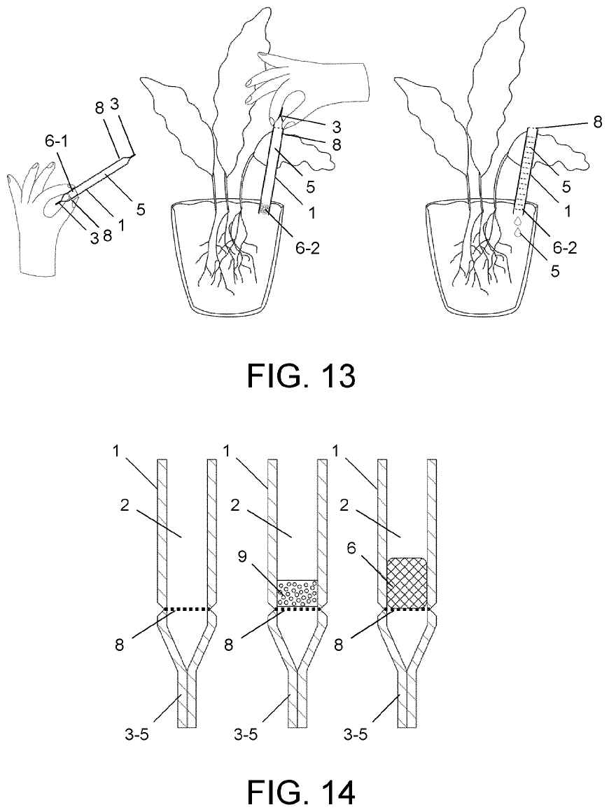

With reference to FIGS. 13 and 14, in embodiments of the invention which comprises a closure 3-5 formed by bonding or welding the walls of the tube 1, the device is activated by cutting the tube 1 between the end and the flow control element 6, or by breaking the tube 1 at the score line 8. The device may be activated at the first end, inserted into the plant substrate, and the tube 1 at the second end broken at the score line 8 to permit the liquid preparation 5 to flow from the part of the lumen 2 to the plant substrate.

With reference to FIG. 22, in one embodiment of the invention, the device comprising an extendable part 1 -8.1 and a flow control element 6-1 is activated by stretching the extendable part 1-8.2 of the tube 1 to deform the flow control element 6-2.

Application of the device comprises activating the first end of the tube 1 by any one of the activation methods described above, and inserting the first end of the tube 1 into a plant substrate device. Wherein, the plant is preferably a potted plant. In embodiments which further comprise a closure 3 at the second end of the tube 1, the closure 3 at the second end of the tube 1 is then activated by any one of the activation methods described above to release the vacuum that exists between the closure 3 at the second end of the tube 1 and the liquid preparation 5 in the lumen 2. The entry of air into the lumen 2 of the tube 1 through the second end of the tube 1 permits the liquid preparation 5 to flow from the part of the lumen 2 to the plant substrate through the first end of the tube 1.

When only the first end is activated, the liquid preparation 5 flows from the lumen 2 of the tube 1 to the plant substrate substantially by capillary forces assisted by gravitational forces. In this case, the device will not suddenly start emptying due to a vacuum that exists between the closure 3 at the second end of the tube 1 and the liquid preparation 5 in the lumen 2. Capillary forces will gradually overcome the vacuum when contact is made between the liquid preparation 5 and the plant substrate. The biggest influence on the strength of the formed vacuum between the closure 3 at the second end of the tube 1 and the liquid preparation 5 in the lumen 2 is the diameter and length of the tube 1 of the device, as well as the characteristics of the liquid preparation 5. In order for the device to start emptying in this embodiment, it is necessary for the liquid preparation 5 in the lumen 2 of the tube 1 to come into direct contact with the plant substrate, which draws the liquid preparation 5 by capillary action. For this reason, the liquid must be close to or next to the first end of the tube 1 so that contact is made between the liquid preparation 5 and plant substrate when the first end of the tube 1 is inserted into the plant substrate.

When both the first and second end are activated, the liquid preparation 5 flows by passive forces, such as by gravitational forces, supported by the capillary forces of the substrate, regardless of the construction solutions and applied preparations.

In one embodiment, the liquid preparation 5 is mixed by shaking the device. This mixing may also be applied to ensure that the liquid preparation 5 is at the first end of the tube 1 before the device is inserted into the plant substrate. In another embodiment, and as discussed above, the drilling element 10 has the ability to capillary, or in some other way, conduct the liquid preparation 5 into the plant substrate.

The flow control element 6 inserted into the lumen 2 of the tube 1 discussed above will also influence the flow rate of the liquid preparation 5 into the plant substrate by gravitational and capillary forces and, depending on the specific needs of the device, elements of certain characteristics may be provided.

### Manufacture of the Device

The device of the invention may be manufactured by any applicable method. For instance, the tube 1 may be prepared by extruding or molding an appropriate plastics material.

The order of formation of the device can vary depending on the needs of the construction of the device, the liquid preparation 5, and also from the construction of the processing machine. Such as, the closure 3 may be attached at the first end of the tube 1, the tube 1 filled with the liquid preparation 5, the flow control element 6 inserted in the lumen 2 of the tube 1, and the closure 3 attached at the second end of the tube 1. Alternatively, the closure 3 may be attached at the first end of the tube 1, the flow control element 6 inserted in the lumen 2 of the tube 1, the tube 1 filled with the liquid preparation 5, and the closure 3 attached at the second end of the tube 1. If necessary during the process, it is possible to insert one or more other elements, such as a mixing element 7 before completely closing the device.

During the manufacturing method, the device may be placed vertically until the flow control element 6 absorbs a significant amount of the liquid preparation 5 and swells so that it cannot move freely in the tank, and thus allowing the device to form and work properly. In order to eliminate the waiting time for the growth of the flow control element 6, it can be previously immersed in a liquid to swell and then be inserted into the tube 1 by compression. Insertion of a swollen flow control element 6 requires compaction, as it may have exceeded the diameter dimensions of the tank. In this case, it is preferably to insert the flow control element 6 before adding the liquid to the tube 1.

Examples according to the disclosure may be formed using an additive manufacturing process. A common example of additive manufacturing is 3D printing; however, other methods of additive manufacturing are available. Rapid prototyping or rapid manufacturing are also terms that may be used to describe additive manufacturing processes.

As used herein, “additive manufacturing” refers generally to manufacturing processes wherein successive layers of material(s) are provided on each other to “build-up” layer-by-layer or “additively fabricate”, a three-dimensional component. This is compared to some subtractive manufacturing methods (such as milling or drilling), wherein material is successively removed to fabricate the part. The successive layers generally fuse together to form a monolithic component which may have a variety of integral sub-components. In particular, the manufacturing process may allow an example of the disclosure to be integrally formed and include a variety of features not possible when using traditional manufacturing methods.

Additive manufacturing processes typically fabricate components based on three-dimensional (3D) information, for example a three-dimensional computer model (or design file), of the component.

Accordingly, examples described herein not only include products or components as described herein, but also methods of manufacturing such products or components via additive manufacturing and computer software, firmware or hardware for controlling the manufacture of such products via additive manufacturing.

The structure of one or more parts of the product may be represented digitally in the form of a design file. A design file, or computer aided design (CAD) file, is a configuration file that encodes one or more of the surface or volumetric configuration of the shape of the product. That is, a design file represents the geometrical arrangement or shape of the product.

Design files can take any now known or later developed file format. For example, design files may be in the Stereolithography or “Standard Tessellation Language” (.stl) format which was created for stereolithography CAD programs of 3D Systems, or the Additive Manufacturing File (.amf) format, which is an American Society of Mechanical Engineers (ASME) standard that is an extensible markup-language (XML) based format designed to allow any CAD software to describe the shape and composition of any three-dimensional object to be fabricated on any additive manufacturing printer.

Further examples of design file formats include AutoCAD (.dwg) files, Blender (.blend) files, Parasolid (.x_t) files, 3D Manufacturing Format (.3mf) files, Autodesk (3 ds) files, Collada (.dae) files and Wavefront (.obj) files, although many other file formats exist.

Design files can be produced using modelling (e.g. CAD modelling) software and/or through scanning the surface of a product to measure the surface configuration of the product.

Once obtained, a design file may be converted into a set of computer executable instructions that, once executed by a processer, cause the processor to control an additive manufacturing apparatus to produce a product according to the geometrical arrangement specified in the design file. The conversion may convert the design file into slices or layers that are to be formed sequentially by the additive manufacturing apparatus. The instructions (otherwise known as geometric code or “G-code”) may be calibrated to the specific additive manufacturing apparatus and may specify the precise location and amount of material that is to be formed at each stage in the manufacturing process. As discussed above, the formation may be through deposition, through sintering, or through any other form of additive manufacturing method.

The code or instructions may be translated between different formats, converted into a set of data signals and transmitted, received as a set of data signals and converted to code, stored, etc., as necessary. The instructions may be an input to the additive manufacturing system and may come from a part designer, an intellectual property (IP) provider, a design company, the operator or owner of the additive manufacturing system, or from other sources. An additive manufacturing system may execute the instructions to fabricate the product using any of the technologies or methods disclosed herein.

Design files or computer executable instructions may be stored in a (transitory or non-transitory) computer readable storage medium (e.g., memory, storage system, etc.) storing code, or computer readable instructions, representative of the product to be produced. As noted, the code or computer readable instructions defining the product that can be used to physically generate the object, upon execution of the code or instructions by an additive manufacturing system.

Accordingly, by controlling an additive manufacturing apparatus according to the computer executable instructions, the additive manufacturing apparatus can be instructed to print out one or more parts of the product. These can be printed either in assembled or unassembled form. For instance, different sections of the product may be printed separately (as a kit of unassembled parts) and then subsequently assembled. Alternatively, the different parts may be printed in assembled form.

In light of the above, embodiments include methods of manufacture via additive manufacturing. This includes the steps of obtaining a design file representing the product and instructing an additive manufacturing apparatus to manufacture the product in assembled or unassembled form according to the design file. The additive manufacturing apparatus may include a processor that is configured to automatically convert the design file into computer executable instructions for controlling the manufacture of the product. In these embodiments, the design file itself can automatically cause the production of the product once input into the additive manufacturing device. Accordingly, in this embodiment, the design file itself may be considered computer executable instructions that cause the additive manufacturing apparatus to manufacture the product. Alternatively, the design file may be converted into instructions by an external computing system, with the resulting computer executable instructions being provided to the additive manufacturing device.

Although additive manufacturing technology is described herein as enabling fabrication of complex objects by building objects point-by-point, layer-by-layer, typically in a vertical direction, other methods of fabrication are possible and within the scope of the present subject matter. For example, although the discussion herein refers to the addition of material to form successive layers, one skilled in the art will appreciate that the methods and structures disclosed herein may be practiced with any additive manufacturing technique or other manufacturing technology.

### INDUSTRIAL APPLICABILITY AND ALTERNATIVE APPLICATIONS

The device according to the present invention is useful in the delivery of fertilizer or pesticides to potted plants, such that the fertilizer or pesticides is delivered at a certain concentration in a controlled manner to the plant substrate, which allows the fertilizer or pesticides to properly distribute throughout the plant substrate, and thus prevents damage to and/or wilting of the plant, or rapid overgrowth of the plant.

The device according to the present invention is also useful in the delivery of a fragrant substance to potted plants to act as attractants and/or repellents for insects and/or pets, and/or room fresheners.

The device, therefore provides a simple solution to the user without the need to learn how to use the device, know how to handle fertilizers and pesticides, as well as the need for knowledge related to growing house flowers, which is of crucial importance for protecting the user and the environment, but also achieving the desired effects of plants.

Although the present invention is primarily described as being useful in feeding plants, the device may also be used more generally in the home as an air freshener, or be beneficial as an attractant and/or repellent for insects, other pests, or pets to the plant or other household furniture.

1. A device in the form of a tube having a lumen and a first and second end for the delivery of a liquid preparation to a plant substrate, wherein the tube comprises:
a flow control element in the lumen which, when contacted with a liquid preparation, absorbs liquid and swells to reduce the flow rate of the liquid preparation from a part of the lumen to the first end; and
a closure at the first end; and
which, once activated by mechanically deforming the flow control element and inserting the first end of the tube into a plant substrate, permits the liquid preparation to flow from the part of the lumen to the plant substrate.

2. The device according to claim 1, wherein the tube comprises a mixing element to mix the liquid preparation in the tube if settling occurs due to standing.

3. The device according to claim 1, wherein the tube comprises an obstacle on the inner surface of the tube which protrudes into the lumen to reduce the flow rate of the liquid preparation.

4. The device according to claim 1, wherein the tube comprises an extendable part with accordion ribs, and wherein the flow control element is positioned in the extendable part.

5. The device according to claim 1, wherein the tube comprises a score line between the first end and/or the second end and the flow control element which structurally weakens the tube and permits the tube to be broken.

6. The device according to claim 1, wherein the device comprises a drilling element to activate the device.

7. The device according to claim 6, wherein the drilling element further conducts the liquid preparation into the plant substrate.

8. The device according to claim 1, wherein the device comprises a modifying element on the outer surface of the tube.

9. The device according to claim 1, wherein the closure and/or the flow control element are in the form of in a cartridge which is inserted into the lumen of the tube at the first or second end.

10. The device according to claim 1, wherein the flow control element is a hydrogel and/or an organic absorber.

11. The device according to claim 1, wherein the hydrogel is sodium polyacrylate and/or potassium polyacrylate.

12. The device according to claim 1, wherein the liquid preparation, the flow control element and/or the modifying element is impregnated with a fragrant substance or combination of fragrant substances.

13. The device according to claim 1, wherein the tube, the flow control element and/or the drilling element is a prebiotic, and/or the tube is impregnated or coated with a prebiotic.

14. A method of activating the device according to claim 1, wherein the method comprises mechanically deforming a part of the closure and a part of the flow control element to permit the liquid preparation to flow from the part of the lumen to the plant substrate.

15. A non-transitory computer-readable storage medium having stored thereon computer executable instructions that, when executed by a processor, cause the processor to control an additive manufacturing apparatus to manufacture the device of claim 1.
